(19) United States
(12) Patent Application Publication
(10) Pub. No.: US 2008/0057868 A1
(43) Pub. Date: Mar. 6, 2008

(54) Auto pairing system and method for bluetooth network

(75) Inventor: Jae Sik Chang, Gumi-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/881,633

(22) Filed: Jul. 27, 2007

(30) Foreign Application Priority Data
Sep. 5, 2006 (KR) 2006-0085015

(51) Int. Cl. H04B 7/00

(52) U.S. Cl. 455/41.2

(57) ABSTRACT

An auto pairing system and method for a Bluetooth network is provided through a wired or wireless coupling. The method for pairing two devices of a short range wireless communication network includes configuring, at each device, a wired and wireless auto pairing of the devices; determining whether the devices are physically coupled with each other; and performing pairing between the devices if the devices are physically coupled. The auto pairing system and method for Bluetooth devices of the present invention enables Bluetooth devices to automatically perform an on-going pairing process through a wired connection or wirelessly in close proximity without a user involvement, thereby improving user convenience.

### CLAIM OF PRIORITY

This application claims priority to an application entitled “AUTO PAIRING SYSTEM AND METHOD FOR BLUETOOTH NETWORK,” filed in the Korean Intellectual Property Office on Sep. 5, 2006 and assigned Serial No. 2006-0085015, the entire contents of which are incorporated herein by reference.

### BACKGROUND OF THE INVENTION

1. Field of the Invention

The present invention relates to a Bluetooth network and, in particular, to an auto pairing system and method for a Bluetooth network through a wired or wireless coupling.

2. Description of the Related Art

Recently, as battery-powered handheld devices have become widely used, low cost and low power consumption wireless technologies have become of major importance. Bluetooth is a radio technology providing a network infrastructure to enable short range wireless communication for data and voice. Bluetooth devices operate in the unlicensed Industrial Scientific Medical (ISM) band at 2.4 Gigahertz and the range for Bluetooth communication is up to 10 meters with a low power consumption of 0 dBm (1 mW). Since Bluetooth is designed as a low power consumption system, Bluetooth is widely used with various handheld devices including mobile phones. Bluetooth can establish an encrypted link between two Bluetooth devices when a symmetric encryption key is created in both of them. This process, called pairing, uses a shared secret identification, known as a PIN that is passed out-of-band, as opposed to over a Bluetooth channel. Bluetooth also provides an authentication process for verifying that the other device has the same encryption key before enabling encryption on the connection between them. During the pairing process, a Bluetooth device searches other devices. If another device is detected, both devices must enter a correct Personal Identification Number (PIN) for establishing an initial link that is used for further identification. Accordingly, a user's attention is required in order to correctly enter the PIN to avoid repeating a cumbersome pairing process. Also, conventional standalone Bluetooth devices are provided with dedicated charge adaptors, requiring a user to carry a charge adaptor for use of the Bluetooth devices on a trip, resulting in inconvenience.

### SUMMARY OF THE INVENTION

The present invention provides an auto pairing method for a Bluetooth device that enables the Bluetooth device to automatically connect to another Bluetooth device when the devices are at least one of in close proximity and connected through a wire.

The present invention also provides a pairing method for a Bluetooth device that is capable of charging as well as pairing through a wire connection to another Bluetooth device.

A method is provided for pairing two devices of a short range wireless communication network. The method for pairing two devices of a short range wireless communication network includes the steps of: configuring, at each device, a wired and wireless auto pairing of the devices; determining whether the devices are physically coupled; and performing pairing between the devices if the devices are physically coupled.

Preferably, the method further includes bridging power of one of the devices to the other device, if a relay charging is requested by the other device.

Preferably, the step of determining whether the devices are physically coupled further includes determining whether the devices are coupled through a wire connection; when the devices are coupled through a wire connection, performing the steps of—
pairing the devices through the wire connection, and
displaying a result of the pairing.

Preferably, the step of determining whether the devices are physically coupled also further includes determining whether the devices are coupled through a wireless connection; measuring a strength of a received signal if the devices are coupled through a wireless connection; determining whether the devices are in close proximity on the basis of the strength of the received signal; if the devices are determined to be in close proximity, performing the steps of—
auto pairing; and
displaying a result of the pairing.

Preferably, the step of performing pairing between the devices includes the steps of—
setting authentication using PIN;
unifying PIN of the Bluetooth devices; and
encrypting data exchanged between the devices.

The above are accomplished by a method for pairing two devices of a short range wireless communication network. The method for pairing two devices includes the steps of: detecting, at each device, a power level of the device; determining whether the devices are coupled with each other through a wire connection; and charging one of the devices using power of the other device.

In another embodiment of the present invention, the foregoing is accomplished by an auto pairing system for a Bluetooth device. The auto pairing system includes a connector for connecting the Bluetooth device to another Bluetooth device; a power detection and switching unit for detecting the power level of the Bluetooth device and establishing a power link to the other Bluetooth device; and a controller for controlling the Bluetooth device to be charged by the power of the other Bluetooth device through the power link if the power level of the Bluetooth device is below a predetermined level.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating a configuration of a Bluetooth auto pairing system according to an embodiment of the present invention;

FIG. 2 is a flowchart illustrating an auto pairing method for Bluetooth devices according to an embodiment of the present invention; and

FIGS. 3a and 3b are flowcharts illustrating an auto pairing method for Bluetooth devices according to another embodiment of the present invention.

### DETAILED DESCRIPTION

Embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

In the present invention, the term “pairing” is used interchangeably with “connecting.”

In the present invention, a wired and wireless auto pairing are introduced. The wired auto pairing is a procedure in which, if two Bluetooth devices are connected with each other through a wire connection, the devices detect the connection and automatically perform a pairing process if the devices are not paired.

The wireless auto pairing is a procedure in which two unpaired devices in close proximity detect the unpaired relationship and automatically perform a pairing process without using a PIN code.

In the present invention, auto pairing-enabled Bluetooth devices can be charged by one another through a wired connection such that the two Bluetooth devices can be simultaneously charged using one charger. For example, an auto pairing-enabled Bluetooth headset can be charged by an auto pairing-enabled Bluetooth mobile phone.

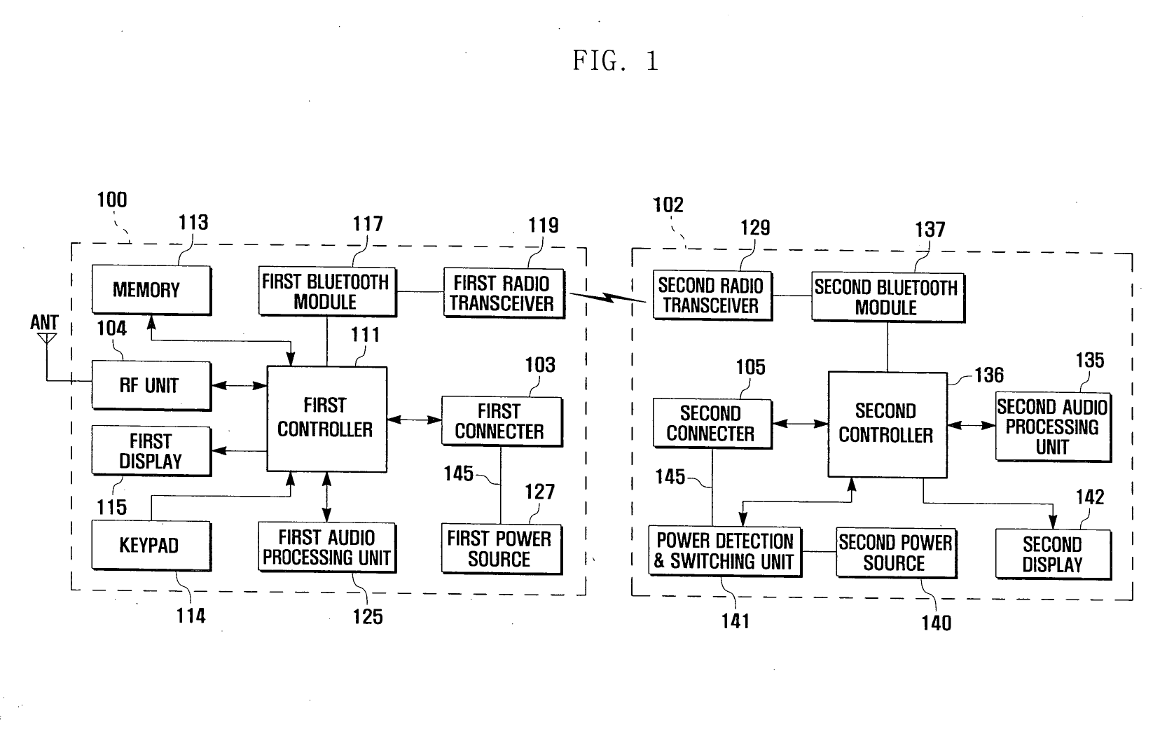

FIG. 1 is a block diagram illustrating a configuration of a Bluetooth auto pairing system according to an embodiment of the present invention.

Referring to FIG. 1, a Bluetooth an example of an auto pairing system includes a Bluetooth-enabled mobile phone 100 and headset 102.

The mobile phone 100 includes a radio frequency (RF) unit 104, a first controller 111, a memory 113, a first display 115, a keypad 114, a first audio processing unit 125, a first connecter 103, a first Bluetooth module 117, a first radio transceiver 119, and a first power source 127.

The headset 102 includes a second controller 136, a second display 142, a second Bluetooth module 137, a second connector 105, a second radio transceiver 129, a second audio processing unit 135, a power detection and switching unit 141, and a second power source 140.

Once the Bluetooth-enabled mobile phone 100 and headset 102 are turned on, the mobile phone 100 and headset 102 transmit signals in respective predetermined transmission powers through the first and second radio transceivers 119 and 129, respectively. In close proximity, the mobile phone 100 and headset 102 receive the signals transmitted from each other and measure the received signal powers to determine whether the received signal powers satisfy conditions for a wireless pairing.

In FIG. 1, the first and second power sources 127 and 140 are simply connected to the first and second connectors 103 and 105 respectively, however, the first and second power sources 127 and 140 are configured to supply power to the internal elements of the mobile phone 100 and headset 102, respectively.

The RF unit 104 of the mobile phone 100 includes an RF transmitter for up-converting and amplifying signal frequency to be transmitted and an RF receiver for low noise amplifying and down-converting signal frequency received through an antenna. The first audio processing unit 125 processes a received audio signal for reproduction through a speaker, and outputs an audio signal input through a microphone to an audio codec.

The memory 113 includes a program memory and a data memory. The program memory stores an operation program associated with general operations of the mobile phone and application programs associated with wire and wireless pairings of the present invention.

The first controller 111 controls overall operations of the mobile phone 100 and, particularly, controls Bluetooth communication including the wired and wireless pairings with the headset 102.

The first display 115 displays operation status of the mobile phone 100 and application data generated by the application programs. In this embodiment of the present invention, the first display 115 displays real-time status of the wired and wireless pairings.

The keypad 114 includes a plurality of alphanumeric keys for inputting data and function keys for executing various functions of the mobile phone 100.

The first connector 103 is a means for establishing a wire connection with the headset 102 for the wired auto pairing.

The first Bluetooth module 117 enables establishment of a Bluetooth connection with the headset 102. The first Bluetooth module 117 measures power strength of a signal transmitted from the headset 102 and outputs the measurement to the first controller 111.

The first radio transceiver 119 exchanges signals associated with the wireless pairing and various control and data signals with the second radio transceiver 129.

The first power source 127 is a battery of the mobile phone 100. The first power source 127 can provide the power to the headset 102 through the first connector 103 when charged power of the headset 102 is low.

The second controller 136 controls operations related to the wired and wireless pairings and Bluetooth communication with the mobile phone 100 and manages a wired connection of the wired pairing between the second connector 105 and the first connector 103 of the mobile phone 100 for charging the headset 102 upon receiving a relay charge request from the second power source 140. The power detection and switching unit 141 monitors variation of power status of the second power source 140 and performs circuit switching for charging the second power source 140.

The second connector 105 enables electrical connection of the headset 102 to the mobile phone 100 for the wired auto pairing and relay charging.

The second audio processing unit 135 processes an audio signal input through a microphone of the headset 102.

The second Bluetooth module 137 enables establishment of a Bluetooth connection with the mobile phone 100. The second Bluetooth module 137 measures power strength of a signal transmitted from the mobile phone 100 and outputs the measurement result to the second controller 136.

The second radio transceiver 129 receives the signals transmitted from the mobile phone 100 before the wireless pairing, and exchanges pairing related signals and various control and data signals with the first radio transceiver 119 of the mobile phone 100.

Each of the mobile phone 100 and headset 102 can be implemented with a separate signal generator for generating wireless pairing control signals and a separate signal strength detector for measuring the received signals. In this case, if the Bluetooth device is turned on, the signal generator generates signals and the signal strength detector measures strength of received signals. If the received signal strength becomes strong enough, the Bluetooth devices perform wireless auto pairing by means of respective Bluetooth modules.

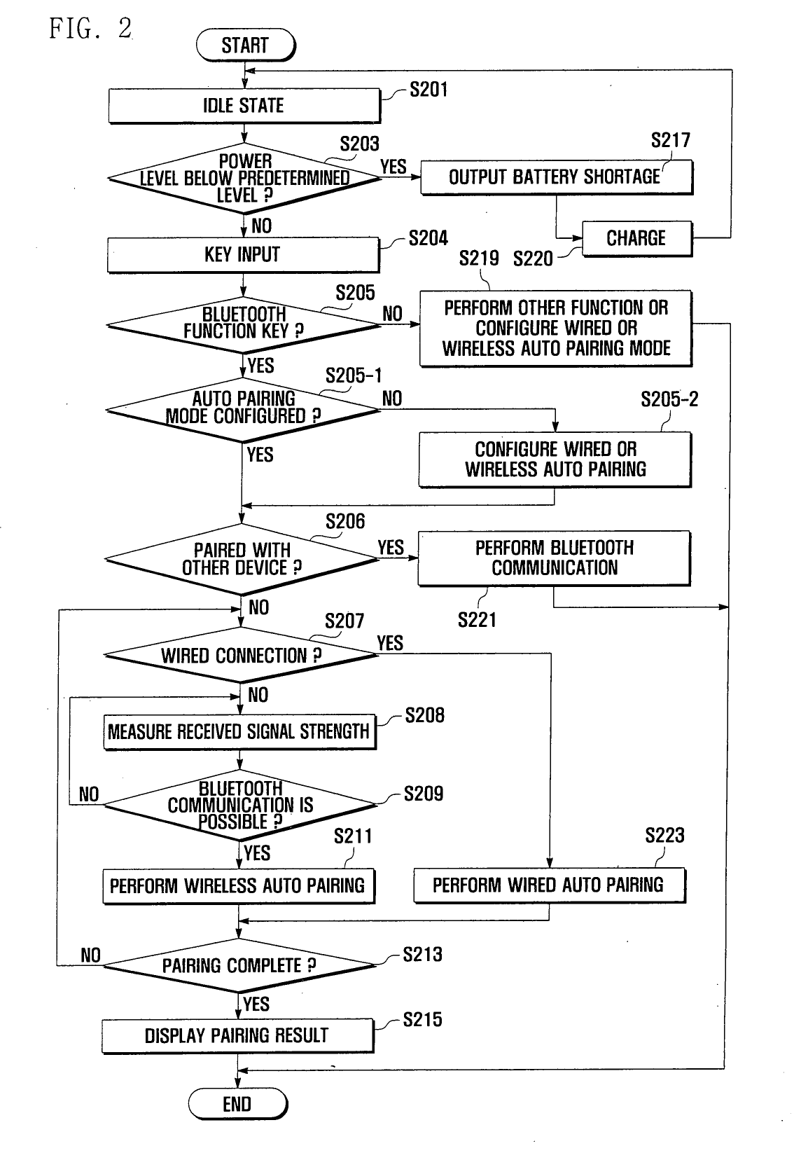

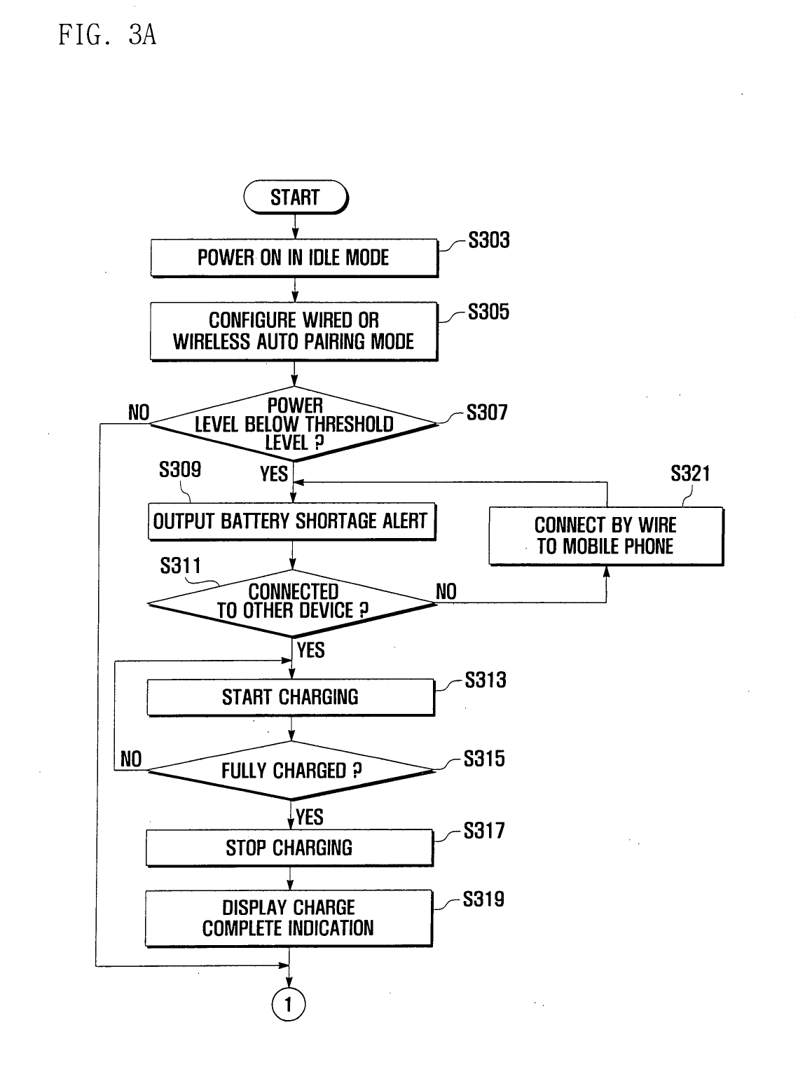

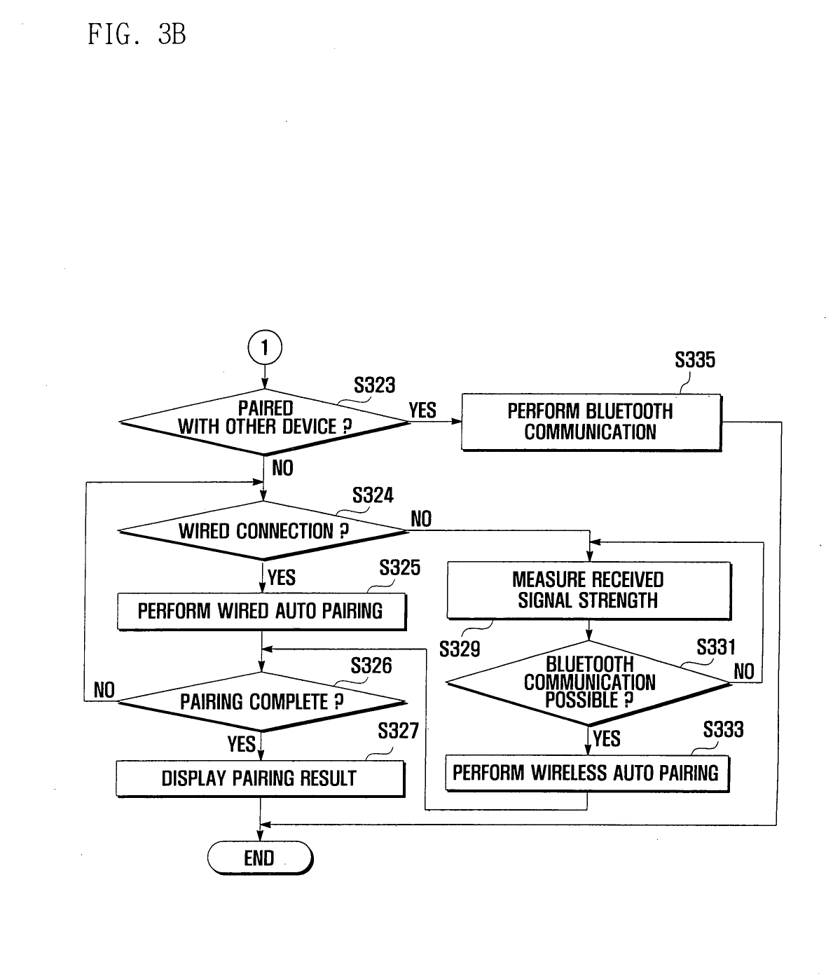

FIG. 2 is a flowchart illustrating an auto pairing method for Bluetooth devices according to an embodiment of the present invention, and FIGS. 3a and 3b are flowcharts illustrating an auto pairing method for Bluetooth devices according to another embodiment of the present invention.

Charge of Headset

In FIG. 1, the second power source 140 of the headset 102 can be a rechargeable battery or a disposable battery. Referring to FIGS. 3a and 3b, the power from the second power source 140 is turned on and the headset 102 is in an idle mode (step S303). The second controller 136 configures the headset 102 for a wired and wireless auto pairing mode (step S305).

The second controller 136 then controls the power detection and switching unit 141 to sense a power level of the second power source 140 (S307). If the sensed power level is below a predetermined threshold level, the second controller 136 outputs at least one of a battery shortage alert on the second display 142 and an alarm sound through an earphone (not shown) (S309). If the first connector 103 of the mobile phone 100 and the second connector 105 of the headset 102 are connected through a wire the second controller 146 of the headset checks the first connector 103 and second connector 105 (step S311) and controls the power detection and switching unit 141 to establish a power line such that the second power source 140 of the headset 102 is charged by the power provided from the first power source 127 of the mobile phone 100 through the power line (step S313). The second controller 136 controls the power detection and switching unit 141 to monitor the power level of the second power source 140 and determines thereby whether the second power source 140 is fully charged (step S315). If the second power source 140 is fully charged, the second controller 136 controls the power detection and switching unit 141 to stop charging (step S317) and displays an indicator informing that the second power source 140 is fully charged on the second display 142 (S319). As a result of charging through the mobile phone 100, the headset 102 does not need to use an additional charger.

Wire and Wireless Pairing

In order to establish a Bluetooth connection between the mobile phone 100 and the headset 102, pairing must be performed. Also, the mobile phone 100 must be in a normal power state in order to normally operate and bridge the power of the mobile phone to the power source of the headset 102. In an idle mode (step S201), the first controller 111 determines whether the power level of the first power source 127 is a predetermined level (step S203). If the power level of the first power source 127 is below a predetermined level, the first controller 111 displays a battery shortage alert (S217) to inform a user of a need to charge the first power source 127 (step S220). If the power level of the first power source 127 is not below a predetermined level, the first controller 111 detects a key input (S204) and determines whether the key input is for activating a Bluetooth function (S205). If the key input is not for activating a Bluetooth function, the first controller 111 controls to execute a function associated with the key input (S219). If the key input is for activating a Bluetooth function, the first controller 111 determines whether an auto pairing function is configured (step S205-1). If an auto pairing function is not configured, the first controller 111 allows the user to configure a wired or wireless auto pairing function (step S205-2).

In the wired and wireless auto pairing mode, the mobile phone 100 and the headset 102 automatically perform the pairing process through a wire connecting the first connector 103 of the mobile phone 100 and the second connector 105 of the headset 102 for the wired auto pairing. Alternatively, the pairing process is accomplished by means of the first Bluetooth module 117 of the mobile phone 100 and the second Bluetooth module 137 of the headset 102 through Bluetooth signal detection between the first radio transceiver 119 and the second radio transceiver 129 in close proximity, when the mobile phone 100 and the headset are not paired.

In order to enable the Bluetooth communication, the first controller 111 of the mobile phone 100 determines whether the mobile phone 100 is paired with the headset 102 (step S206), and the second controller 136 of the headset 102 determines whether the headset 102 is paired with the mobile phone 100 (step S323). If the mobile phone 100 is not paired with the headset 102, the pairing process should be performed. The first and second controller 111 and 136 of the mobile phone 100 and headset 102, respectively, determine whether the mobile phone 100 and the headset 102 are connected through a wire by means of the first and second connectors 103 and 105 (step S207 and step S324).

If the mobile phone 100 and the headset 102 are connected through a wire, the first controller 111 of the mobile phone 100 and the second controller 136 of the headset 102 perform the wired auto pairing (step S223 and step S325). The wired auto pairing is accomplished in such a manner that the first controller 111 of the mobile phone 100 and the second controller 136 of the headset 102 perform exchange authentication, PIN exchange, and encryption information exchange according to settings configured for the wired auto pairing.

If the mobile phone 100 and the headset 102 are not connected through a wire at steps S207 and S324, the first controller 111 of the mobile phone 100 and the second controller 136 of the headset 102 measure Bluetooth signal strengths received through the respective first and second radio transceivers 119 and 129 (step S208 and step S329). Next, the first controller 111 of the mobile phone 100 and the second controller 136 of the headset 102 determine whether the mobile phone 100 and the headset 102 are in an available Bluetooth communication range (step S209 and step S331). If the mobile phone 100 and the headset 102 are in an available Bluetooth communication range, the first controller 111 of the mobile phone 100 and the second controller 136 of the headset 102 perform a wireless auto pairing (step S211 and step S333). The wireless auto pairing is performed when the mobile phone 100 and the headset are in sufficiently close proximity, as determined by the Bluetooth signal strengths. The first controller 111 of the mobile phone 100 and the second controller 136 of the headset 102 perform the wireless auto pairing by exchanging the authentication, PIN, and encryption information through the first and second Bluetooth modules 117 and 137 and the first and second radio transceivers 119 and 129. The first controller 111 of the mobile phone 100 and the second controller 136 of the headset 102 determine whether the pairing is complete (step S213 and step S326) while processing the appropriate wired or wireless auto pairing. If the pairing is complete, the first controller 111 of the mobile phone 100 and the second controller 136 of the headset 102 display the pairing result on the first display 115 and second display 142 (step S215 and step S327).

In this embodiment, the present invention is described with a Bluetooth mobile phone and a Bluetooth headset. However, the present invention is not limited thereto, but can be adapted for pairing all kinds of Bluetooth devices and other short range communication network devices.

Although exemplary embodiments of the present invention are described in detail hereinabove, it should be clearly understood that many variations and/or modifications of the basic inventive concepts herein taught which may appear to those skilled in the present art will still fall within the spirit and scope of the present invention, as defined in the appended claims.

As described above, the auto pairing system and method for Bluetooth devices of the present invention enable Bluetooth devices to automatically perform a pairing process through a wired connection or wirelessly in close proximity without a user involvement, thereby improving user convenience.

Also, the auto pairing system and method for Bluetooth devices of the present invention are advantageous in that a Bluetooth device, when connected to another Bluetooth device through a wire, can be charged by a power source of the other Bluetooth device while performing an auto pairing process therewith.

What is claimed is:

1. A method for a pairing of two devices of a short range wireless communication network, comprising:
configuring, at each device of the two devices, a wired and wireless auto pairing of the two devices;
determining whether the configured two devices are physically coupled one with the other; and
performing pairing between the two devices when it is determined that the two devices are physically coupled one with the other.

2. The method of claim 1, further comprising the step of bridging power of one of the two devices to the other of the two devices, if a relay charging is requested by the other of the two devices.

3. The method of claim 1, wherein the step of determining whether the devices are physically coupled one with the other further comprises the steps of:
determining whether the two devices are coupled one with the other through a wire connection;
when it is determined that the devices are coupled one with the other through the wire connection, pairing the two devices one with the other through the wire connection; and
displaying a result of the pairing.

4. The method of claim 1, wherein the step of determining whether the two devices are physically coupled one with the other further comprises the steps of:
determining whether the two devices are coupled one with the other through a wireless connection;
when it is determined that the two devices are coupled one with the other through a wireless connection, performing the steps of:
measuring strength of a received signal at each of the two coupled devices;
determining whether the two coupled devices are in close proximity on the basis of the measured strength of the received signal being greater than a pre-determined threshold value;
performing wireless auto pairing if the devices are in close proximity; and
displaying a result of the pairing.

5. The method of claim 1, wherein the step of performing pairing between the devices further comprises the steps of:
setting authentication using PIN;
unifying PIN of the two devices; and
encrypting data exchanged between the two devices.

6. A method for pairing two devices of a short range wireless communication network, comprising the steps of:
detecting, at each of the two devices, a power level of the device;
determining whether the two devices are coupled one with the other through a wire connection; and
charging one of the two devices using power of the other of the two devices.

7. An auto pairing system for a network of a plurality of Bluetooth devices, comprising:
a connector for connecting a first Bluetooth device of said plurality of Bluetooth devices to a second Bluetooth device of said plurality of Bluetooth devices;
a power detection and switching unit for detecting a power level of the first Bluetooth device and establishing a power link therefrom to the second Bluetooth device; and
a controller for controlling the second Bluetooth device to be charged by the power of the first Bluetooth device through the power link if the power level of the second Bluetooth device is below a predetermined threshold level.

8. The auto pairing system of claim 7, wherein the power link is a wire.
